(19) United States
(12) Patent Application Publication
(10) Pub. No.: US 2016/0162796 A1
(43) Pub. Date: Jun. 9, 2016

(54) COMBINATION SELECTING METHOD AND SYSTEM USING THE SAME

(71) Applicant: INSTITUTE FOR INFORMATION INDUSTRY, TAIPEI CITY (TW)

(72) Inventor: JING-TIAN SUNG, TAIPEI CITY (TW)

(21) Appl. No.: 14/569,915

(22) Filed: Dec. 15, 2014

(30) Foreign Application Priority Data
Dec. 9, 2014 (CN) 201410750678.1

(51) Int. Cl. G06N 5/04; F23N 5/24

(52) U.S. Cl. CPC G06N 5/048; F23N 5/242

(57) ABSTRACT

A combination selecting method comprises the following steps: firstly, selecting a fixed number of sources from a plurality of the sources to generate a plurality of predictive combinations; next, filtering the predictive combinations by a parameter to generate a group associating with the predictive combinations satisfied by the parameter; then, altering a part of the sources of each predictive combination to generate a new predictive combination correspondingly from each predictive combination, and filtering the new predictive combinations by the parameter to add into the group; finally, repeating performing the previous step until the total number of all predictive combinations achieves a goal.

### BACKGROUND

1. Technical Field

The present disclosure relates to a combination selecting method, in particular to a combination selecting method and system using the same.

2. Description of Related Art

In thermal power plants, fuel cost usually accounts for more than 70% of the total cost of generating electricity. Thus, how to reduce fuel cost is the main way to raise the benefit of the thermal power plant. There are two ways to reduce the fuel cost currently, one is reducing the quantity of coal while generating electricity, and another is cost down the price of coal. The quantity of coal used to generate electricity can be improved by updating the generators, but high cost is usually spent updating and the effect may be not outstanding. Additionally, cost down of the price of coal can be realized by reducing the purchase price or co-firing different coals. The price of coal is controlled in seller's market, thus reducing the purchased price is not easy. Therefore, perhaps co-firing different coals is the most feasible way to reduce the price of coal.

The generator generates the electricity by firing the coals, however different coals may cause different effects and characteristics. This is accompanied by the issue of optimizing or limitation of a range of parameters. In practice, if the class or essence of the coals deviates from expectations, operating stability or the employee's safety becomes compromised.

Traditionally, the process of coal planning is according to the assay of each coal bunker to perform planning, so as to achieve the goal of co-firing for coals within the safe range. However, this way not only wastes manpower, but also low efficiency and high coal consumption affects the generator so coal planning does not achieve the ideal goal.

### SUMMARY

An exemplary embodiment of the present disclosure provides a combination selecting method including the following steps: firstly, selecting a fixed number of sources from a plurality of the sources to generate a plurality of predictive combinations; next, filtering the predictive combinations by a parameter to generate a group associating with the predictive combinations satisfying the parameter; then, altering a part of the sources of each predictive combination to generate a new predictive combination corresponding from each predictive combination, and filtering the new predictive combinations by the parameter to add into the group; finally, repeating performing the previous step until the total number of all predictive combinations achieves a goal.

An exemplary embodiment of the present disclosure provides a combination selecting system including a plurality of storages and a combination selecting device. The combination selecting device includes a source selecting module and a calculating module. The combination selecting device couples to the storages. The calculating module couples to the source selecting module. The storages are configured to store a plurality of sources respectively. The source selecting module is configured to select a fixed number of sources from a plurality of the sources to generate a plurality of predictive combinations. The calculating module is configured to filter the predictive combinations by a parameter to generate a group associating with the predictive combinations satisfying the parameter. The calculating module is configured to alter a part of the sources of each predictive combination to generate a new predictive combination corresponding from each predictive combination and filter the new predictive combinations by the parameter to add into the group. Furthermore, the calculating module is configured to repeat the previous steps until the total number of all predictive combinations achieves a goal.

To sum up, the combination selecting method and system provided by the present disclosure can improve these defects such that the planning software follows rules associating limitations without considering previously unknown variables. Furthermore, the embodiment of the present disclosure provides a quick way of searching a plurality of feasible solutions in a formula process with multiple variables. In other words, while the target goal is defined even though the limitations may be unclear, a plurality of formula results are suggested within a feasible range from enormous amount of data generated by the multiple variables, thus calculating time and cost of traditional planning software can be reduced, and even the damage of the apparatus is improved in system.

In order to further understand the techniques, means and effects of the present disclosure, the following detailed descriptions and appended drawings are hereby referred to, such that, and through which, the purposes, features and aspects of the present disclosure can be thoroughly and concretely appreciated, however, the appended drawings are merely provided for reference and illustration, without any intention that they be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a diagram of a combination selecting system of an embodiment according to the present disclosure;

FIG. 2 is a diagram of a combination selecting method of an embodiment according to the present disclosure;

FIG. 3 is a diagram of coal planning applied to an embodiment according to the present disclosure;

FIG. 4 is a flow chart of calculating and selecting new predictive combinations in the combination selecting method of the embodiment according to the present disclosure;

FIG. 5 is a diagram of the dot product utilized to calculate and select the new predictive combinations in coal planning applied the embodiments according to the present disclosure;

FIG. 6 is a diagram of the distance utilized to calculate and select the new predictive combinations in coal planning applied the embodiments according to the present disclosure;

### DESCRIPTION OF THE EXEMPLARY EMBODIMENTS

Reference will now be made in detail to the exemplary embodiments of the present disclosure, examples of which are illustrated in the accompanying drawings. However, they may be embodied in different forms and should not be construed as limited to the embodiments set forth herein. In the drawings, the thickness and relative thickness of layers and regions may be exaggerated for clarity. Wherever possible, the same reference numbers are used in the drawings and the description to refer to the same or like parts.

The embodiment of the present disclosure provides approximated or similar predictive combinations by predetermining the combination selected from a plurality of sources, to repeatedly calculate all feasible predictive combinations. Successively, a suggestion table can be generated upon ordering all predictive combinations satisfied by the requirement of the operator. Therefore, the present disclosure provides a plurality of formula results that are suggested within a feasible range from an enormous amount of data generated by the multiple variables. The detail of the embodiments is illustrated as following.

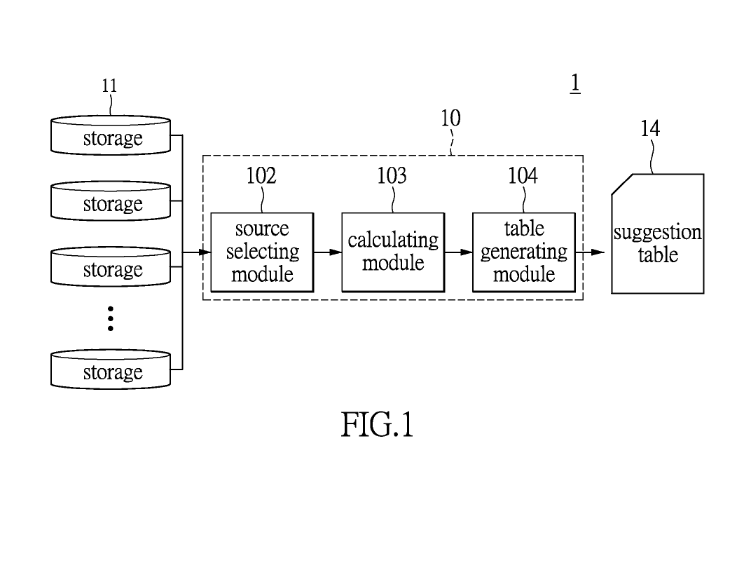

Please refer to FIG. 1. FIG. 1 is a diagram of a combination selecting system of an embodiment according to the present disclosure. The combination selecting system 1 includes a plurality of storages 11, a combination of selecting device 10, and a suggestion table 14. The combination selecting device 10 includes a source selecting module 102, a calculating module 103, and a table generating module 104. The combination selecting device 10 couples to the storages 11. The calculating module 103 couples to the source selecting module 102, and the table generating module 104 couples to the calculating module 103.

The storages 11 are configured to store the sources used by the operator or user. More specifically, the storages 11 can store food, beverage, medicine, fuel, or paint, such as any raw material that can be mixed or combined. In the embodiment of the present disclosure, the storages 11 store each type of coal according to such as different place of production or different time stored in the bunker.

The combination selecting device 10 is configured to select the sources according to the requirements. The source selecting module 102 including suitable logic, circuitry, and/or code, is configured to select a fixed number of sources from a plurality of the storages 11 to generate a plurality of predictive combinations. In the embodiment of present disclosure, the source selecting module 102 selects “5” to be the fixed number of coal bunkers. Each coal bunker stores a plurality of types of coal to generate the predictive combinations. Notably, the capacity of each coal crushed machine shall be different because each coal bunker has different length of service or other factors. Thus, each coal bunker having the same coal still has different variables. In other words, the source selecting module 102 utilizes a combination with repetition to perform selection from the coal bunkers.

The calculating module 103 including suitable logic, circuitry, and/or code, is configured to filter the predictive combinations by a parameter to generate a group associating with the predictive combinations satisfying the parameter. In detail, the calculating module 103 calculates a characteristic result associated with each predictive combination to compare with a parameter after the source selecting module 102 selects the predictive combinations. Meanwhile, the calculating module 103 generates the group associating with the predictive combinations satisfying the parameter.

However, while the calculating module 103 selects a set having a fixed number of the sources from the storages 11, which can be according to a random selection or a predetermined combination list with the sources to provide the predictive combinations. Notably, the random selection may be such that the calculating module 103 selects the sources from the storages 11 randomly; perhaps the calculating module 103 utilizes a predetermined combination list such as the user's experience to perform the selection.

Additionally, in the embodiment of the present disclosure, the parameter is the limitation of a characteristic result required by the operator or user. The characteristic result such as at least one of a density of sulfide (SOx), a density of nitrides (NOx), an amount of ash, an erosion property, an accumulation property, a clinkering property, a quantity of coal, and a capacity of coal feeder. For example, the operator can setup the parameter such that the density of sulfides is “1” to filter the predictive combinations being less than “1”. It is noted that the embodiment is illustrated by coal planning, but the parameter is not limited in the present disclosure. The parameter also can be replaced by food, beverage, medicine, fuel, or paint as known by the persons skilled in the art.

The calculating module 103 further alters a part of the sources of each predictive combination to generate a new predictive combination correspondingly from each, and then filters the new predictive combinations by the parameter to add into the group again. More specifically, after the predicated combinations are filtered according to the parameter, the calculating module 103 calculates a geometric center associated with the predictive combinations of the group to provide a plurality of new predictive combinations such as “approximating to” or “removing from” the geometric center. Taking the coal planning, after a group generated by coal planning combinations is filtered according to the parameter, the calculating module 103 further alters a part of the sources of each coal planning combination by the geometric center associated with all coal planning combinations to search other new coal planning combinations. In the embodiment of the present disclosure, the geometric center is a center of gravity or a center of mass. Thereafter, the calculating module 103 adds the new coal planning combinations filtered according to the same parameter into the group.

Successively, the calculating module 103 repeats performing the previous steps until the total number of all predictive combinations achieves a goal. In detail, after the new coal planning combinations are searched to add into the group, if the calculating module 103 judges that the goal of the operator is not achieved, the calculating module 103 repeats to calculate a new geometric center associated with the predictive combinations and the new predictive combinations, so as to search other predictive combinations approximating to or removing from the new geometric center. It is worth noting that the goal is a fixed frequency of times by the operator or a predetermined number of the predictive combinations within the group.

The table generating module 104 including suitable logic, circuitry, and/or code, is configured to order the predictive combinations and the new predictive combinations of the group based on the parameter after the calculating module 103 achieves the goal, and generates the suggestion table 14. More specifically, the table generating module 104 further orders all predictive combinations according to the value of characteristic results or suggestions, to provide the feasible predictive combinations for the operator or user. In the embodiment of coal planning, the table generating module 104 generates a coal planning of the suggestion table to list the predictive combinations satisfying less than “1” of the density of sulfides, to provide to the operator selecting the bunkers for generating electricity.

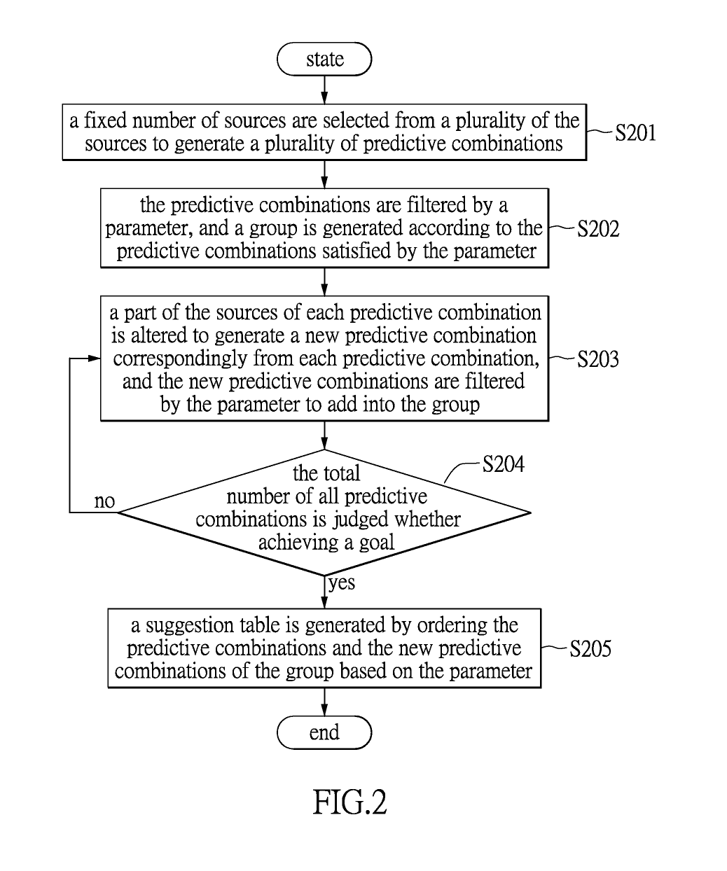

Please refer to FIG. 2. FIG. 2 is a diagram of a combination selecting method of an embodiment according to the present disclosure. The combination selecting method includes the following steps: STEP S201, a fixed number of sources are selected from a plurality of the sources to generate a plurality of predictive combinations; STEP S202, the predictive combinations are filtered by a parameter, and a group is generated according to the predictive combinations that satisfy the parameter; STEP S203, a part of the sources of each predictive combination is altered to generate a new predictive combination correspondingly from each predictive combination, and the new predictive combinations are filtered by the parameter to add into the group; STEP S204, the total number of all predictive combinations is judged whether achieving a goal; STEP S205, repeating performing the previous step until the total number of all predictive combinations achieve a goal.

Please refer to FIG. 2 in conjunction with FIG. 1. In the STEP S201, the source selecting module 102 is configured to select “5” to be the fixed number of coal bunkers. Each coal bunker stores a plurality of sources to generate the predictive combinations, the sources are such as types of coal. The source selecting module 102 selects the sources of each coal bunker to generate a plurality of predictive combinations while generating electricity, so as to estimate the property for each predictive combination.

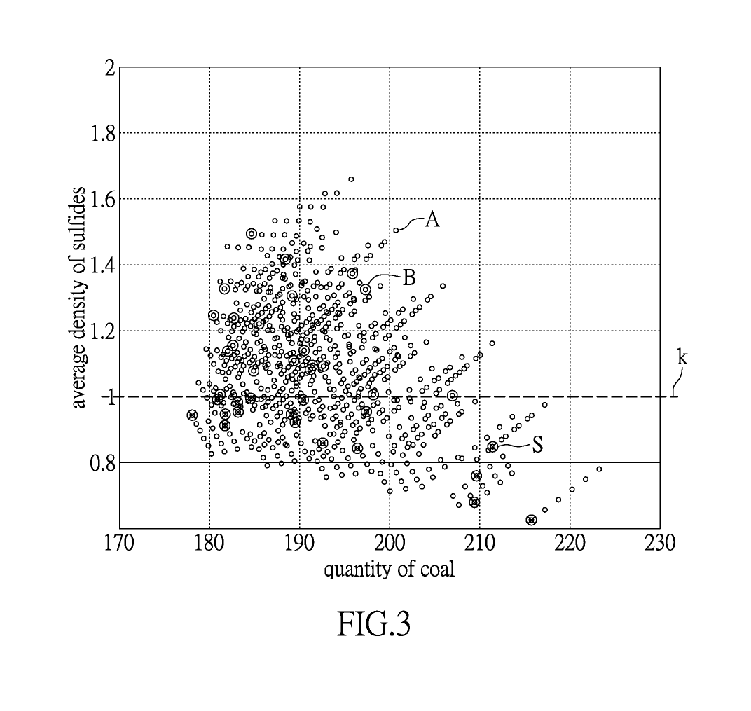

Please refer to FIG. 3. FIG. 3 is a diagram of coal planning applied to an embodiment according to the present disclosure. In the STEP S202, the predictive combinations selected by the calculating module 102 are calculated to obtain the characteristic result of each predictive combination. Thereafter, the characteristic result of each predictive combination is compared with the parameter of the operator to filter the predictive combinations satisfied by the parameter. Therefore, a group is generated from a set of the predictive combinations satisfied by the parameter. As shown in FIG. 3, “k” is the parameter or limitation of the average density of sulfur oxides, points A are substantially existing combinations, and points B are the predictive combinations generated by the fixed number of sources selected from a plurality of the sources. In other words, the group is the set of the predictive combinations being less than “1” of average density of sulfur oxides.

Successively, in the STEP S203, the calculating module 103 further alters a part of the sources of each predictive combination to generate a new predictive combination correspondingly from each predictive combination, and filters the new predictive combinations by the parameter to add into the group after the previous predictive combinations satisfied the parameter are filtered.

In the STEP S204, after the new predictive combinations are searched to add into the group, the calculating module 103 judges whether the goal of the operator is achieved. If the calculating module 103 judges the goal of the operator is not achieved, other new predictive combinations will be re-searched again in the STEP S203. On the contrary, if the calculating module 103 judges the goal of the operator is achieved, the STEP S205 is entered.

In the STEP S205, the table generating module 104 further orders all predictive combinations according to the value of the characteristic result or the suggestion, to provide the feasible predictive combinations for operator or user. In other words, the table generating module 104 provides a predetermined amount of the feasible solutions for the operator or user.

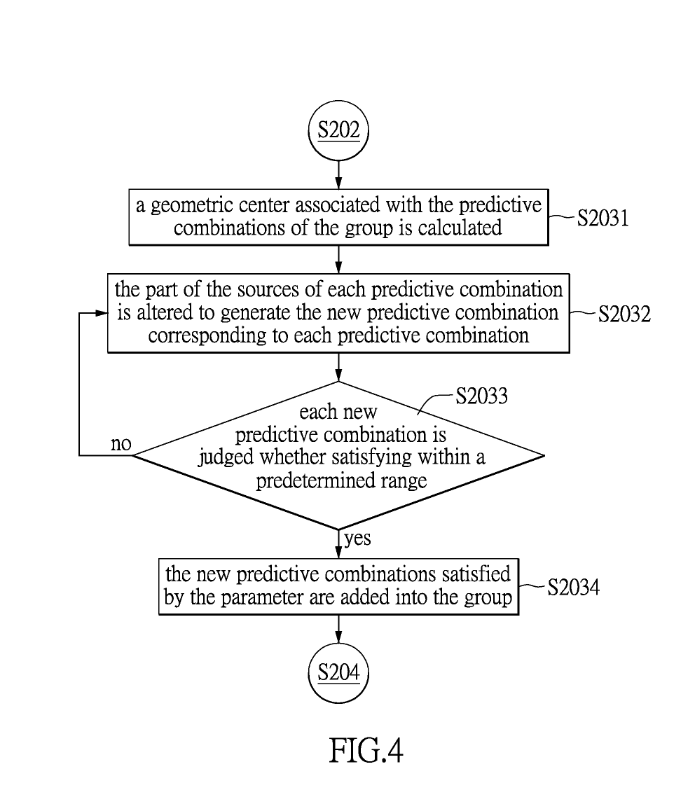

Please refer to FIG. 4. FIG. 4 is a flow chart of calculating and selecting new predictive combinations in the combination selecting method of the embodiment according to the present disclosure. The combination selecting method includes the following steps: STEP S2031, a geometric center associated with the predictive combinations of the group is calculated; STEP S2032, the part of the sources of each predictive combination is altered to generate the new predictive combination corresponding to each predictive combination; STEP S2033, each new predictive combination is judged whether satisfying within a predetermined range; STEP S2034, the new predictive combinations satisfying the parameter are added into the group.

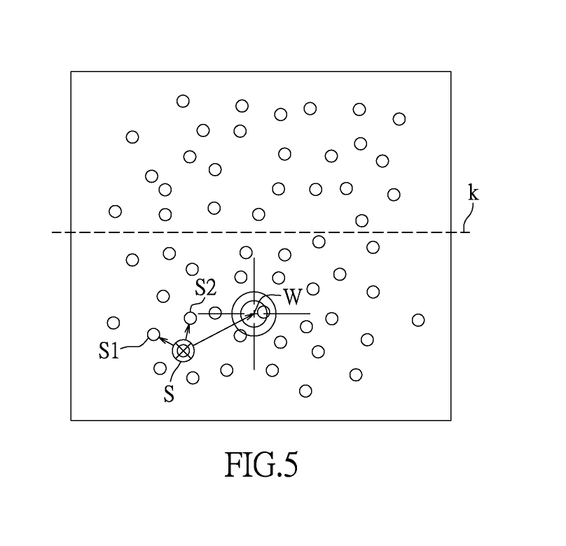

Please refer to FIG. 5 in conjunction with FIG. 4. FIG. 4 is a flow chart of calculating and selecting new predictive combinations in the combination selecting method of the embodiment according to the present disclosure. In FIG. 5, point W is shown as the geometric center, and points S1, S2 are the new predictive combinations.

In STEP S2031, the calculating module 103 further calculates the geometric center W associated with all predictive combinations S. For example, the geometric center W is utilized by the center of mass:

$$R = \frac{1}{M} {\sum }_{i = 1}^{N} {m}_{i} {r}_{i} , \qquad ( 1 )$$

rᵢ is shown as the i-th generation or requirement for coal, such as the quantity of coal, the sulfides emission quantity, the nitrides emission quantity, the generation of ash, etc. (as shown in FIG. 4, the variables are as the average density of sulfides and the quantity of coal), mᵢ is shown as the mass of the point such as “1” in the embodiment of the present disclosure (i.e., the calculating average). Additionally, M is shown as the total of all mᵢ.

Next, after the geometric center W is calculated, in the STEP S2032 the part of the sources of each predictive combination is altered to generate the new predictive combination corresponding to each predictive combination. As shown as FIG. 5, the altered part of the sources of each predictive combination can be searched from the neighbors of the predictive combination such as the new predictive combination S1 and S2.

Furthermore, after the new predictive combination S1 and S2 are searched, in the STEP S2033 the new predictive combination S1 and S2 are judged whether satisfying within a predetermined range. More specifically, in FIG. 5, the embodiment of the present disclosure is judged by the dot product between a vector from each predictive combination S to each new predictive combination S1 or S2 and another vector from each predictive combination S to the geometric center W, to judge whether the new predictive combination S1 or S2 is approximating to or removing from the geometric center W. For example, while the dot product between a vector from each predictive combination S to each new predictive combination S1 or S2 and another vector from each predictive combination S to the geometric center W is greater than zero, the new predictive combination S1 or S2 is judged to approximate to the geometric center W. On the contrary, while the dot product between a vector from each predictive combination S to each new predictive combination S1 or S2 and another vector from each predictive combination S to the geometric center W is less than zero, the new predictive combination S1 or S2 is judged to be removing from the geometric center W. In other words, in the embodiment of the present disclosure the predetermined range is limited by the dot product. However, the operator or user can be based on the requirement to search the new predictive combinations approximating to (the result of dot product is greater than zero) or removing from (the result of dot product is less than zero) the geometric center, as the searching target of the predetermined range, wherein the safe predictive combinations can be expressed by “approximating” and the damage predictive combinations can be expressed by “removing”. When the new predictive combinations S1 or S2 are satisfied within the predetermined range, the STEP S2034 is entered. When the new predictive combination S1 or S2 are not satisfied within the predetermined range, return to STEP S2032 to repeat altering the part of the sources of each predictive combination to generate a new predictive combination. In the STEP S2034, the new predictive combination S1 or S2 satisfying the parameter is added into the group. Thereafter, the total number of all predictive combinations is judged as to whether it has achieved the goal and returns to STEP S204 again.

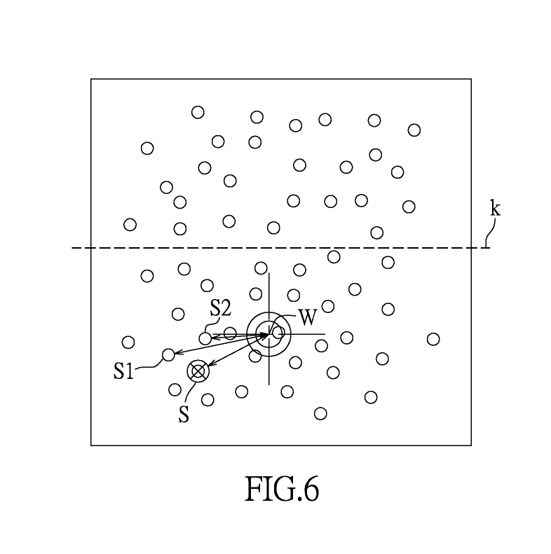

Additionally, please refer to FIG. 6. FIG. 6 is a diagram of the distance utilized to calculate and select the new predictive combinations in coal planning applied the embodiments according to the present disclosure. The embodiment in FIG. 6 is judged according to a comparison between a distance from each predictive combination S to the geometric center W and another distance from each new predictive combination S1 or S2 to the geometric center W. More specifically, in the STEP S2033, while the distance from each predictive combination S to the geometric center W is less than another distance from each new predictive combination S1 or S2 to the geometric center W, the new predictive combination S1 or S2 is judged to be approximating to the geometric center W. On the contrary, while the distance from each predictive combination S to the geometric center W is longer than another distance from each new predictive combination S1 or S2 to the geometric center W, the new predictive combination S1 or S2 is judged to be removing from the geometric center W. Similarly, the operation or use also can be based on the requirement to search the new predictive combinations approximating to (the comparison of distance is less) or removing from (the comparison of distance is longer) the geometric center, as the searching target of the predetermined range.

To sum up, the combination selecting method and system provided by the present disclosure can improve these defects such that planning software follows rules associating limitations without considering previously unknown variables. Furthermore, the embodiment of the present disclosure provides a quick way of searching a plurality of feasible solutions in a formula processed with multiple variables. In other words, while the situation such as the target is defined even though the limitation may be unclear, a plurality of formula results are suggested within a feasible range from an enormous amount of data generated by the multiple variables, thus calculating time and cost of traditional planning software can be reduced, and even damage to apparatus is improved in the system.

The above-mentioned descriptions represent merely the exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A combination selecting method, comprising the following steps:
(A) selecting a fixed number of sources from a plurality of the sources, to generate a plurality of predictive combinations;
(B) filtering the predictive combinations by a parameter to generate a group associating with the predictive combinations satisfied by the parameter;
(C) altering a part of the sources of each predictive combination to generate a new predictive combination correspondingly from each predictive combination, and filtering the new predictive combinations by the parameter to add into the group; and
(D) repeating to perform the step (C) until the total number of all predictive combinations achieves a goal.

2. The combination selecting method according to claim 1, wherein in the step (A), a set having the fixed number of sources is selected according to a random selection or a predetermined combination list with the sources to provide the predictive combinations.

3. The combination selecting method according to claim 1, wherein in the step (D), the goal is a fixed frequency of times or a predetermined number of the predictive combinations within the group.

4. The combination selecting method according to claim 3, further comprising the following step:
(F) generating a suggestion table by ordering the predictive combinations and the new predictive combinations of the group based on the parameter.

5. The combination selecting method according to claim 1, wherein in the step (B), a geometric center associated with the predictive combinations of the group, is calculated after the generation of the group.

6. The combination selecting method according to claim 5, wherein in the step (C), the part of the sources of each predictive combination is altered to generate the new predictive combination approximating to the geometric center.

7. The combination selecting method according to claim 6, wherein when the dot product between a vector from each predictive combination to each new predictive combination and another vector from each predictive combination to the geometric center is greater than zero, the new predictive combination is judged to approximate to the geometric center.

8. The combination selecting method according to claim 6, wherein when a distance from each predictive combination to the geometric center is less than another distance from each new predictive combination to the geometric center, the new predictive combination is judged to approximate to the geometric center.

9. The combination selecting method according to claim 5, wherein in the step (C), the part of the sources of each predictive combination is altered to generate the new predictive combination removing from the geometric center.

10. The combination selecting method according to claim 9, wherein when the dot product between a vector from each predictive combination to each new predictive combination and another vector from each predictive combination to the geometric center is less than zero, the new predictive combination is judged to be removing from the geometric center.

11. The combination selecting method according to claim 9, wherein when a distance from each predictive combination to the geometric center is longer than another distance from each new predictive combination to the geometric center, the new predictive combination is judged to be removing from the geometric center.

12. The combination selecting method according to claim 5, wherein the geometric center is a center of gravity or a center of mass.

13. The combination selecting method according to claim 1, wherein after the step (A), a characteristic result of each predictive combination is calculated to compare with the parameter.

14. The combination selecting method according to claim 13, wherein the sources is obtained from coal bunkers.

15. The combination selecting method according to claim 14, wherein a combination with repetition is utilized to perform selecting from the coal bunkers.

16. The combination selecting method according to claim 14, wherein the characteristic result comprises at least one of a density of sulfides (SOx), a density of nitrides (NOx), an amount of ash, an erosion property, an accumulation property, a clinkering property, a quantity of coal, and a capacity of coal feeder.

17. A combination selecting system, comprising:
a plurality of storages, configured to store a plurality of sources respectively;
a combination selecting device, coupled to the storages, comprising:
a source selecting module, configured to select a fixed number of sources from a plurality of the sources to generate a plurality of predictive combinations; and
a calculating module, coupled to the source selecting module, configured to filter the predictive combinations by a parameter to generate an group associating with the predictive combinations satisfied by the parameter; configured to alter a part of the sources of each predictive combination to generate a new predictive combination correspondingly from each predictive combination, and filter the new predictive combinations by the parameter to add into the group; and further configured to repeat the previous steps until the total number of all predictive combinations achieves a goal.

18. The combination selecting system according to claim 17, wherein the source selecting module selects a set having the fixed number of sources according to a random selection or a predetermined combination list with the sources to provide the predictive combinations.

19. The combination selecting system according to claim 17, wherein the calculating module calculates a geometric center associated with the predictive combinations of the group after the generation of the group.

20. The combination selecting system according to claim 19, wherein the calculating module alters the part of the sources of each predictive combination to generate the new predictive combination approximating to or removing from the geometric center.
